(19) United States
(12) Patent Application Publication
(10) Pub. No.: US 2009/0107777 A1
(43) Pub. Date: Apr. 30, 2009

(54) PARKING BRAKE DEVICE OF DISK BRAKE

(75) Inventor: Jin Seok Kim, Seoul (KR)

Correspondence Address: LADAS & PARRY, 5670 WILSHIRE BOULEVARD, SUITE 2100, LOS ANGELES, CA, 90036-5679, US

(73) Assignee: MANDO CORPORATION, Gyeonggi-do (KR)

(21) Appl. No.: 12/259,556

(22) Filed: Oct. 28, 2008

(30) Foreign Application Priority Data
Oct. 29, 2007 (KR) 10-2007-108938

(51) Int. Cl. F16D 55/08

(52) U.S. Cl. 188/72.7

(57) ABSTRACT

Disclosed is a parking brake device of a disk brake. The parking brake device includes a caliper housing including a finger unit and a body part to push pad plates, which are installed at both sides of a disk, to closely make contact with the disk, a cylinder provided in the body part of the caliper housing, a piston slidably provided in the cylinder to move the pad plates toward the disk by using driving force generated from hydraulic pressure or mechanical thrust force, a cam unit provided at a rear portion of the cylinder to transform rotation motion of a parking brake lever into linear motion of the piston, and including an operating shaft, a ramp, and a ball, and a push rod which delivers linear motion of the cam unit into the piston. A flange part of the push rod is coupled to an open front end of the ramp having a cylindrical shape by using grooves or protrusions, so that the push rod is easily prevented from rotating.

### CROSS-REFERENCE TO RELATED APPLICATION

This application claims the benefit of Korean Patent Application No. 10-2007-0108938 filed on Oct. 29, 2007, in the Korean Intellectual Property Office, the disclosure of which is incorporated herein by reference.

### BACKGROUND OF THE INVENTION

1. Field of the Invention

The present invention relates to a parking brake device of a disk brake. More particularly, the present invention relates to a mechanical parking brake device installed in a caliper housing.

2. Description of the Related Art

In general, since a brake device is mounted on a vehicle wheel, brake force is generated through manipulation of a brake pedal in driving, or through manipulation of a parking brake lever in parking, so that a braking state can be maintained.

Hereinafter, a disk brake equipped with a parking brake device disclosed in U.S. Pat. No. 5,060,765 will be described with reference to FIG. 1 as an example of a parking brake device having the above structure. As shown in FIG. 1, in the disk brake, a parking brake lever 38 is rotatably installed at one side of a body part 20 of a caliper housing 10 including pad plates 14 and 16 and a disk 12. The parking brake lever 38 is shafted with a shaft 34 so that a ramp 46 and a ball 48 can slide. The shaft 34 makes contact with a piston 30 connected with a push rod 50 in the body part 20.

Accordingly, when a driver pulls a brake handle in order to park a vehicle, the parking brake lever 38 rotates, and then the shaft 34 shafted with the parking brake lever 38 rotates. The shaft 34 is guided by the ball 48 to perform linear motion along an inclined groove of the ramp 46 while rotating. Simultaneously, the shaft 34 pushes the push rod 50 to operate the piston 30. Finally, the piston 30 pushes the pad plates 14 and 16 to the disk 12 such that the pad plates 14 and 16 closely make contact with the disk 12, thereby generating brake force.

However, in the above structure, if the ramp 46 rotates with the shaft 34, the ball 48 cannot move along an inclined surface of the ramp 46. Accordingly, the shaft 34 does not perform linear motion so that the piston 30 cannot operate. Therefore, in order to prevent the ramp 46 from rotating, a through hole 25 is provided at one internal portion of the body part 20, and a fixing pin protruding from the ramp 46 is inserted into the through hole 25.

Similarly, regarding the push rod 50, in order to prevent the push rod 50 from rotating in relation to an adjust 60 that adjusts a distance between the disk 12 and the pad plates 14 and 16 by relatively rotating with respect to the piston 30, an end 74 of a return spring cage 72 provided through the push rod 50 and the return spring 70 must be fixed to a cylinder.

However, since the return spring cage 72 is fixed in the body part 20 by using an additional fixing member in order to prevent the push rod 50 from rotating, assembling the brake device is complex. In addition, the performance of the brake device may be degraded due to the friction between the return spring cage 72 and the push rod 50.

### SUMMARY OF THE INVENTION

Accordingly, it is an aspect of the present invention to provide a parking brake device of a disk brake capable of easily preventing a push rod from rotating.

Additional aspects and/or advantages of the invention will be set forth in part in the description which follows and, in part, will be apparent from the description, or may be learned by practice of the invention.

The foregoing and/or other aspects of the present invention are achieved by providing a parking brake device of a disk brake. The parking brake device includes a caliper housing including a finger unit and a body part to push pad plates, which are installed at both sides of a disk, to closely make contact with the disk, a cylinder provided in the body part of the caliper housing, a piston slidably provided in the cylinder to move the pad plates toward the disk by using driving force generated from hydraulic pressure or mechanical thrust force, a cam unit provided at a rear portion of the cylinder to transform rotation motion of a parking brake lever into linear motion of the piston, and including an operating shaft, a ramp, and a ball, and a push rod which delivers linear motion of the cam unit into the piston. The push rod is coupled with an open front end of the ramp such that the push rod is prevented from rotating.

According to an aspect of the present invention, the push rod of the parking brake device of the disk brake comprises a body part and a flange part, the flange part is provided with at least one groove or protrusion, and the ramp is provided with at least one restriction protrusion or restriction groove coupled with the at least one groove or protrusion of the flange part, respectively.

According to an aspect of the present invention, the ramp of the parking brake device of the disk brake has a cylindrical shape, and has a rear surface detachable from a body of the ramp.

As described above, in the parking brake device of the disk brake according to the present invention, a flange part of a push rod is coupled to an open front end of a ramp having a cylindrical shape by using grooves or protrusions, so that the rotation of the push rod can be easily prevented.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view showing a parking brake device of a conventional disk brake;

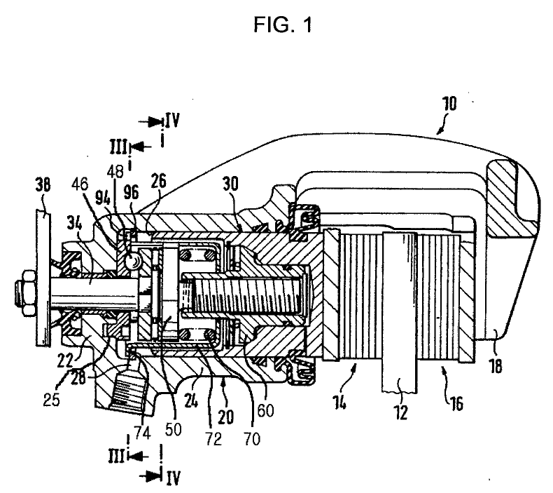

FIG. 2 is a view showing a parking brake device of a disk brake according to one embodiment of the present invention;

FIG. 3 is an exploded perspective view showing a portion of the parking brake device of FIG. 2; and

FIG. 4 is an exploded perspective view showing a portion of a parking brake device of a disk brake according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements. The embodiments are described below to explain the present invention by referring to the figures.

Hereinafter, a parking brake device of a disk brake according to an exemplary embodiment of the present invention will be described in detail with reference to accompanying drawings.

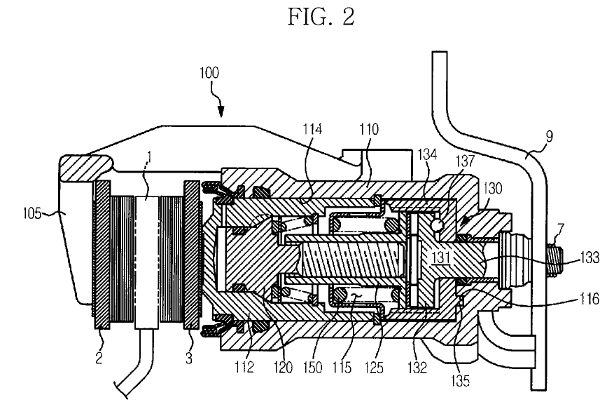

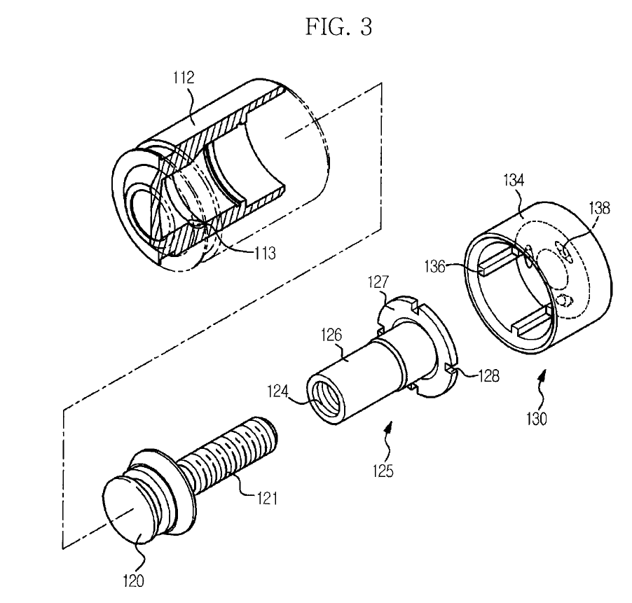

FIG. 2 is a sectional view schematically showing a disk brake equipped with a parking brake device according to the present invention, and FIG. 3 is an exploded perspective view showing a portion of the disk brake shown in FIG. 2.

Referring to FIGS. 2 and 3, the disk brake presses both lateral side surfaces of a disk 1, which rotates with a wheel, by using a pair of pad plates 2 and 3 to stop the rotation of the wheel. The disk brake includes a caliper housing 100 accommodating a finger part 105 and a body part 110 integrated with each other while interposing the disk 1 between the finger part 105 and the body part 110. Since the pad plates 2 and 3 are movably coupled to a carrier (not shown) fixed to a vehicle, the finger part 105 and the body part 110 move to the center of the disk 1 from left and right sides of the disk 1, so that the pad plates 2 and 3 closely make contact with the disk 1.

The body part 110 of the caliper housing 100 includes an opened cylinder 114 provided at a side of the disk 1 in order to receive a piston 112 used to move the pad plates 2 and 3 to the disk 1. The cylinder 114 is provided at a rear portion thereof with a cam unit 130 to transform rotation motion of the parking brake lever 9 into linear motion of the piston 112. The cam unit 130 includes an operating shaft 131, a ramp 134, and a ball 137 interposed between the shaft 131 and the ramp 134, and details thereof will be described later.

The piston 112 has the shape of a cylinder with an internal empty space, and is slidably inserted into the cylinder 114. The piston 112 forms a predetermined compression chamber 115 with the cylinder 114. Accordingly, if hydraulic pressure is provided from a master cylinder (not shown), the compression chamber 15 is expanded to move forward the piston 112.

An adjust 120 is provided in the piston 112. In this case, an air discharge hole 113 is formed in the piston 112 such that hydraulic pressure smoothly circulates. The adjust 120 maintains a distance between the pad plates 2 and 3 and the disk 1 in order to prevent the pad plates 2 and 3, which are gradually abraded, from being away from the disk 1. The adjust 120 is rotatably inserted into the piston 112, and provided at an outer circumference thereof with a thread 121. The thread 121 is screwed with one end of the push rod 125 making contact with the operating shaft 131 of the cam unit 130.

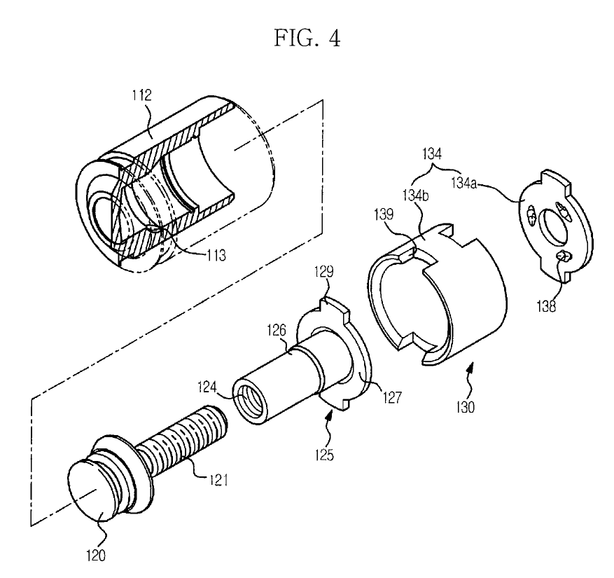

As shown in FIG. 3, the push rod 125 includes a body part 126 and a flange part 127. The body part 126 includes a hollow formed at an inner circumference thereof with a female screw to be coupled with the thread 121 formed at the outer circumference of the adjust 120. The flange part 127 is provided with a plurality of grooves (see 128 of FIG. 3) or a plurality of protrusions (see 129 of FIG. 4) to be coupled with the ramp 134 of the cam unit 130, and details thereof will be described later.

Meanwhile, the cylinder 114 may be provided at an inside (e.g., a rear portion) thereof with the cam unit 130 such that the cylinder 114 not only operates by the hydraulic pressure as described above, but operates through the rotation of the parking brake lever 9. As described above, the cam unit 130 includes the operating shaft 131, the ramp 134, and the ball 137.

The operating shaft 131 has a shape of “T” and includes a flange part 132 and a shaft 133. The flange part 132 has a disk shape and makes contact with the push rod 125, and the shaft 133 is shafted with the parking brake lever 9 through the body part 110.

The ramp 134 has the shape of a hollow cylinder. The ramp 134 is provided at a front surface thereof with a guide groove 138 to guide the ball 137 such that the operating shaft 131 can perform linear motion. The ramp 134 is provided with a protrusion 135 which protrudes from a rear surface and is inserted into a coupling hole 116 provided in the body part 110 in order to prevent the ramp 134 from rotating. As shown in FIG. 4, a rear surface 134a of the ramp 134 may be separated from a ramp body part 134b for the purpose of easy processing.

Restriction protrusions (136 of FIG. 3) and restriction grooves (139 of FIG. 4) are provided at a rim of an open front end of the ramp 134. The restriction protrusions (136 of FIG. 3) and the restriction grooves (139 of FIG. 4) are coupled to the grooves (128 of FIG. 3) and the protrusions (129 of FIG. 4) provided on the flange part 127 of the push rod 125 to prevent the push rod 125 from rotating. Accordingly, the push rod 125 advances toward or retreats from the ramp 134 in a state in which the rotation of the push rod is restricted.

Hereinafter, the operation of the disk brake having the above structure according to the present invention will be described with reference to FIG. 2.

If a driver presses a pedal, hydraulic pressure is generated in the master cylinder. The hydraulic pressure is introduced into the compression chamber 115 provided in the cylinder 114 through an oil inlet provided in the caliper housing 100. The compression chamber 115 is expanded to move the piston 112 to the disk 1. As a result, the pad plate 3 provided at one side of the caliper housing 10 closely makes contact with the disk 1, and the body part 110 is pushed backward due to continuous pressure expansion so that the finger part 105 allows the pad plate 2 provided at the other side of the caliper housing 10 to closely make contact with the disk 1. Accordingly, the wheel is stopped.

Meanwhile, if the driver pulls up a hand brake for parking, a parking cable (not shown) is tensioned so that the parking brake lever 9 is rotated. Accordingly, the operating shaft 131 shafted with the parking brake lever 9 in the body part 110 is rotated. Subsequently, the ball 137 moves along the guide groove 138 of the ramp 134 so that the operating shaft 131 performs linear motion. Therefore, the push rod 125 making contact with the flange part 132 of the operating shaft 131 is moved to the disk 1 to operate the piston 112, so that the pad plates 2 and 3 closely make contact with the disk 1.

Meanwhile, if the driver releases the hand brake, the push rod 125 is moved backward by the return spring provided in the cylinder 114, so that the operating shaft 131 returns to its initial state, and the parking brake lever 9 exactly returns to its initial position by a torsion spring 7.

Although few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A parking brake device of a disk brake, the parking brake device comprising:
a caliper housing including a finger unit and a body part to push pad plates, which are installed at both sides of a disk, to closely make contact with the disk;
a cylinder provided in the body part of the caliper housing;
a piston slidably provided in the cylinder to move the pad plates toward the disk by using driving force generated from hydraulic pressure or mechanical thrust force;
a cam unit provided at a rear portion of the cylinder to transform rotation motion of a parking brake lever into linear motion of the piston, and including an operating shaft, a ramp, and a ball; and
a push rod which delivers linear motion of the cam unit into the piston,
wherein the push rod is coupled with the ramp such that the push rod is prevented from rotating.

2. The parking brake device of claim 1, wherein the push rod comprises a body part and a flange part, the flange part is provided with at least one groove or protrusion, and the ramp is provided with at least one restriction protrusion or restriction groove coupled with the at least one groove or protrusion of the flange part, respectively.

3. The parking brake device of claim 1, wherein the ramp has a cylindrical shape, and has a rear surface detachable from a body of the ramp.
